(19) United States
(12) Patent Application Publication
(10) Pub. No.: US 2006/0265637 A1
(43) Pub. Date: Nov. 23, 2006

(54) Utilization of podcasts on portable media devices

(75) Inventors: Greg Marriott, Palo Alto, CA (US); Jesse Boettcher, San Jose, CA (US); Richard Atwell, Cupertino, CA (US); David Heller, San Jose, CA (US); Amandeep Jawa, San Francisco, CA (US)

Correspondence Address: BEYER WEAVER & THOMAS, LLP, P.O. BOX 70250, OAKLAND, CA, 94612-0250, US

(73) Assignee: Apple Computer, Inc.

(21) Appl. No.: 11/166,333

(22) Filed: Jun. 25, 2005

Related U.S. Application Data
(60) Provisional application No. 60/683,056, filed on May 21, 2005.

(51) Int. Cl. G06F 17/00; G06F 15/00; G06F 17/21

(52) U.S. Cl. 715/500.1

(57) ABSTRACT

Improved techniques to facilitate use of podcasts on a portable media device are disclosed. A podcast to be played can be located on the portable media device and then played for the benefit of a user. According to one aspect, a podcast can be located on the portable media device using hierarchical menus. According to another aspect, metadata for a podcast can be displayed while the podcast is being played. The metadata can be changed in response to user input or can be dynamically changed without user input.

### CROSS-REFERENCE TO RELATED APPLICATIONS

This application claims priority to U.S. Provisional Patent Application No. 60/683,056, filed May 21, 2005, and entitled “TECHNIQUES AND SYSTEMS FOR SUPPORTING PODCASTING” [Att.Dkt.No.: APL1P405P], which is hereby incorporated by reference herein. In addition, U.S. Provisional Patent Application No. 60/______, filed Jun. 25, 2005, and entitled “TECHNIQUES AND SYSTEMS FOR SUPPORTING PODCASTING” [Att.Dkt.No.: APL1P427P] is hereby incorporated by reference herein.

This application is related to: (i) U.S. patent application Ser. No. ______, filed concurrently herewith, and entitled “TECHNIQUES AND SYSTEMS FOR SUPPORTING PODCASTING” [Att.Dkt.No.: APL1P426], which is hereby incorporated by reference herein; (ii) U.S. patent application Ser. No. ______, filed concurrently herewith, and entitled “ACQUISITION, MANAGEMENT AND SYNCHRONIZATION OF PODCASTS” [Att.Dkt.No.: APL1P427], which is hereby incorporated by reference herein; (iii) U.S. patent application Ser. No. 10/282,861, filed Oct. 28, 2002, and entitled “GRAPHICAL USER INTERFACE AND METHODS OF USE THEREOF IN A MULTIMEDIA PLAYER” [Att.Dkt.No.: APL1P239], which is hereby incorporated herein by reference; (iv) U.S. patent application Ser. No. 10/277,418, filed Oct. 21, 2002, and entitled “INTELLIGENT INTERACTION BETWEEN MEDIA PLAYER AND HOST COMPUTER” [Att.Dkt.No.: APL1P228X1], which is hereby incorporated herein by reference; and (v) U.S. patent application Ser. No. 10/118,069, filed Apr. 5, 2002, and entitled “INTELLIGENT SYNCHRONIZATION OF MEDIA PLAYER WITH HOST COMPUTER” [Att.Dkt.No.: APL1P228], which is hereby incorporated herein by reference.

### BACKGROUND OF THE INVENTION

1. Field of the Invention

The present invention relates to podcasts and, more particularly, to acquiring and playing podcasts on a portable media device.

2. Description of the Related Art

A media player stores media assets, such as audio tracks, that can be played or displayed on the media player. One example of a portable media player is the iPod® media player, which is available from Apple Computer, Inc. of Cupertino, Calif. Often, a media player acquires its media assets from a host computer that serves to enable a user to manage media assets. In managing media assets, a user can create playlists for audio tracks. These playlists can be created at the host computer. Media assets within the playlists can then be copied to the media player. As an example, the host computer can execute a media management application to create and manage media assets. One example of a media management application is iTunes® produced by Apple Computer, Inc.

Podcasts are typically used to share content from websites. Podcasts are associated with Really Simple Syndication (RSS) feeds which use a lightweight XML format. A podcast can be organized into episodes much like a radio or television program. An interested person can subscribe to receive podcast episodes that are subsequently published. This is achieved by the interested person using their computer to access a podcast website that hosts the RSS feed. The interested person can then subscribe the RSS feed such that their computer occasionally re-visits the podcast website to check for any new podcast episodes. Typically, if a new podcast episode is available, it is downloaded to the computer. Thereafter, the interested user can play the podcast episode at their computer in the same manner as other audio files (e.g., MP3 files). A utility program can be used to download the audio files to a portable media player (e.g., MP3 player). One example of such a conventional utility program is “ipodder” which is a small program that runs on one's computer to download audio files to one's portable media player.

Unfortunately, podcasts are conventionally not easily utilized on portable media players. Often, a portable media player has a limited display screen but can hold many media assets. As a result, locating a desired podcast to be played on a portable media player is conventionally cumbersome. Another difficultly is that podcasts typically include not only audio data but also may include graphic or video data. Providing a portable media player with audio and graphic/video capabilities to adequately display and play podcasts is a challenging task.

Thus, there is a need for improved techniques to facilitate use of podcasts on portable media players.

### SUMMARY OF THE INVENTION

The invention pertains to techniques to facilitate use of podcasts on a portable media device. A podcast to be played can be located on the portable media device and then played for the benefit of a user. According to one aspect, a podcast can be located on the portable media device using hierarchical menus. According to another aspect, metadata for a podcast can be displayed while the podcast is being played. The metadata can be changed in response to user input or can be dynamically changed without user input.

The invention can be implemented in numerous ways, including as a method, system, device, apparatus (including graphical user interface), or computer readable medium. Several embodiments of the invention are discussed below.

As a method for utilizing podcasts on a portable media device, one embodiment of the invention includes at least the acts of: navigating, in response to user navigation inputs, through a series of hierarchically ordered lists pertaining to podcasts that are stored on the portable media device, each of the podcasts being stored on the portable media device having audio data and metadata; selecting, in response to a user selection input, a podcast to be played following the navigation; initiating playing of audio data for the selected podcast by the portable media device; displaying, during the playing of at least an initial portion of the audio data, initial metadata for the selected podcast on a display associated with the portable media device; and displaying, during at least a subsequent portion of the playing of the audio data, subsequent metadata for the selected podcast on the display associated with the portable media device.

As a method for utilizing podcasts on a portable media device, one embodiment of the invention includes at least the acts of: navigating through a series of lists pertaining to podcasts that are stored on the portable media device, each of the podcasts being stored on the portable media device having audio data and metadata; subsequently selecting a podcast to be played; initiating playing of audio data for the selected podcast by the portable media device; and displaying metadata for the selected podcast on a display associated with the portable media device, wherein at least a portion of the metadata being displayed is dependent on an elapsed play time for the selected podcast.

As a method for utilizing podcasts on a portable media device, one embodiment of the invention includes at least the acts of: identifying a podcast stored on the portable media device; initiating playing of audio data for the identified podcast by the portable media device; and displaying metadata for the selected podcast on a display associated with the portable media device, the displaying of the metadata being concurrent with the playing of the audio data for the identified podcast.

As a method for navigating media items available on a media device having a display screen, one embodiment of the invention includes at least the acts of: displaying a first list including at least audio categories, the audio categories including at least a podcast category; determining whether the podcast category has been selected from the first list; displaying a second list when it is determined that the podcast category has been selected, the second list including at least textual descriptors for available podcasts on the portable media device; determining whether one of the available podcasts has been selected from the second list; displaying a third list when it is determined that one of the available podcasts has been selected from the second list, the third list including at least textual descriptors for available episodes for the selected podcast; and determining whether one of the available episodes has been selected from the third list.

As a computer readable medium including at least computer program code for utilizing podcasts on a portable media device, one embodiment of the invention includes at least: computer program code for identifying a podcast stored on the portable media device; computer program code for initiating playing of audio data for the identified podcast by the portable media device; and computer program code for displaying metadata for the selected podcast on a display associated with the portable media device, the computer program code for displaying being concurrent with the playing of the audio data for the identified podcast.

As a method operating on a portable, pocket-sized multimedia asset player for selecting and playing a multimedia asset from a group of multimedia assets stored therein, one embodiment of the invention includes at least the act of displaying at a home interface, a playlist list item corresponding to a number of playlists stored in the multimedia asset player, wherein each playlist is a group of multimedia assets, an artists item corresponding to a number of artists each of which is associated with at least one of the stored multimedia assets, a songs list item associated with each of the stored multimedia assets; and a podcasts list item corresponding to a number of playlists stored in the multimedia asset player. The embodiment further includes the acts of: highlighting a desired one of the playlist list item, the artists item, the songs list item or the podcasts list item; receiving a selection of the highlighted item; and automatically transitioning to a second interface based upon the selected item.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a flow diagram of a podcast utilization process according to the one embodiment of the invention.

FIGS. 2A and 2B are flow diagrams of a podcast navigation process according to one embodiment of the invention.

FIG. 2C is a flow diagram of a podcast navigation process according to another embodiment of the invention.

FIGS. 3A-3D represent a series of representative screen shots of navigation screens that can be displayed on a display screen of a portable media device to assist its user in navigating through a plurality of podcasts according to one embodiment of the invention.

FIGS. 3E-3I represent screen shots that depict different representative metadata pertaining to a podcast being played on a portable media device.

FIG. 3J is a screen shot of a podcast playing window according to one embodiment of the invention.

FIG. 4 is a flow diagram of a metadata update process according to one embodiment of the invention.

FIG. 5 is a flow diagram of a dynamic metadata process according to one embodiment of the invention.

FIG. 6 is a flow diagram of a chapter metadata presentation process according to one embodiment of the invention.

FIG. 7A is a diagram of a representative electronic file pertaining to a podcast according to one embodiment of the invention.

FIG. 7B is a diagram of a representative electronic file pertaining to a podcast according to another embodiment of the invention.

FIG. 8 is a block diagram of a media system according to one embodiment of the invention.

FIG. 9 is a block diagram of a media management system according to one embodiment of the invention.

FIG. 10 is a block diagram of a media player suitable for use with the invention.

### DETAILED DESCRIPTION OF THE INVENTION

The invention pertains to techniques to facilitate use of podcasts on a portable media device. A podcast to be played can be located on the portable media device and then played for the benefit of a user. According to one aspect, a podcast can be located on the portable media device using hierarchical menus. According to another aspect, metadata for a podcast can be displayed while the podcast is being played. The metadata can be changed in response to user input or can be dynamically changed without user input.

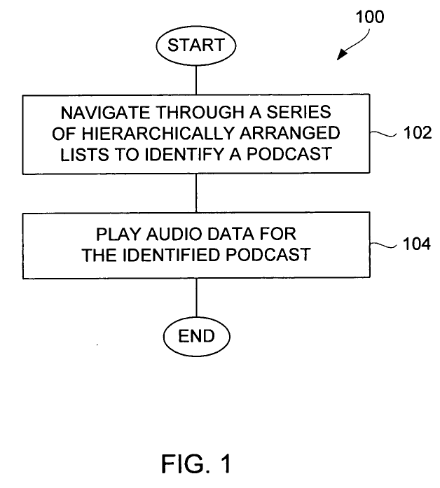

Embodiments of the invention are discussed below with reference to FIGS. 1-10. However, those skilled in the art will readily appreciate that the detailed description given herein with respect to these figures is for explanatory purposes as the invention extends beyond these limited embodiments.

A podcast is a particular type of audio file that can include or have metadata associated therewith. The metadata describes attributes of the podcast, such as title, description, chapter names, and images (graphics). A podcast can refer to or be associated with a show that is periodically published (e.g., weekly show). Such a show typically has periodic episodes. The episodes are the podcasts that can be played. More specifically, audio data for the episodes can be played, thereby playing the podcasts.

According to one aspect, a podcast can be located on a portable media device using hierarchical lists (e.g., menus). The advantage of using hierarchical lists is that a user of a portable media device is able to efficiently choose a particular podcast from a substantial number of podcasts.

FIG. 1 is a flow diagram of a podcast utilization process 100 according to one embodiment of the invention. The podcast utilization process 100 is typically performed on a portable media device. The portable media device stores a plurality of podcasts that can be played by the portable media device.

The podcast utilization process 100 initially permits a user to navigate 102 through a series of hierarchically arranged lists to identify a podcast. Here, the user can navigate through the series of hierarchically arranged lists to identify a particular podcast from the plurality of podcasts stored on the portable media device. The hierarchically arranged lists are selectively presented to a user of the portable media device through a graphical user interface produced on a display of the portable media device. By interacting with the portable media device, the user can make selections with respect to the lists. For example, the user can interact with the portable media device through a user input device (e.g., keypad, dial, touch surface, etc.) or through voice commands. In one embodiment, the hierarchically arranged lists can be menus.

A podcast principally comprises audio data that can be processed (i.e., played) by the portable media device so as to output the audio sounds of the podcast. Hence, after a particular podcast has been identified by the navigation 102, audio data for the identified podcast can be played 104. After audio data for the identified podcast has been played 104, the podcast utilization process 100 ends.

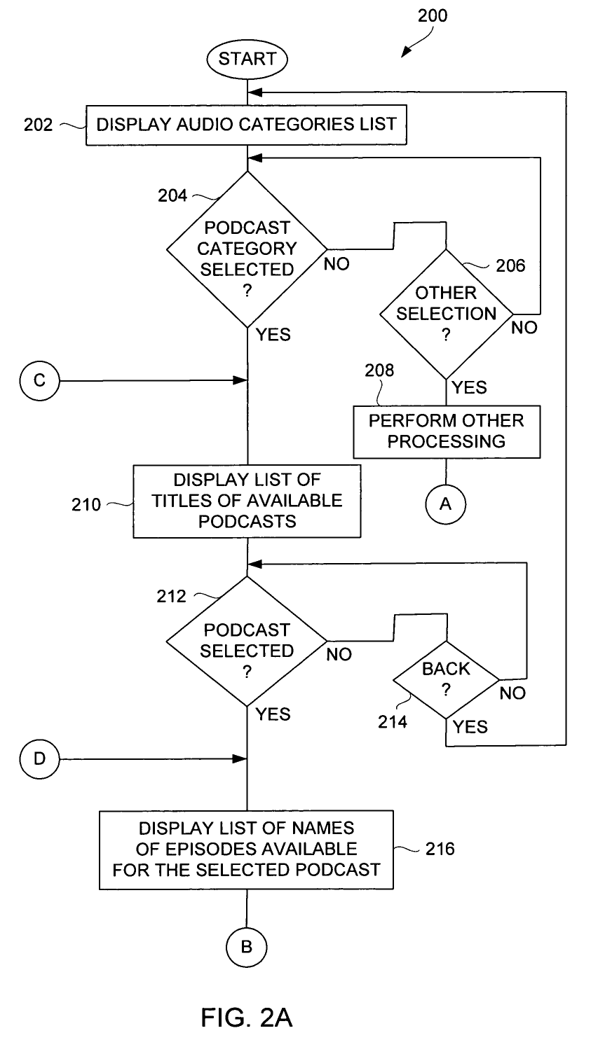

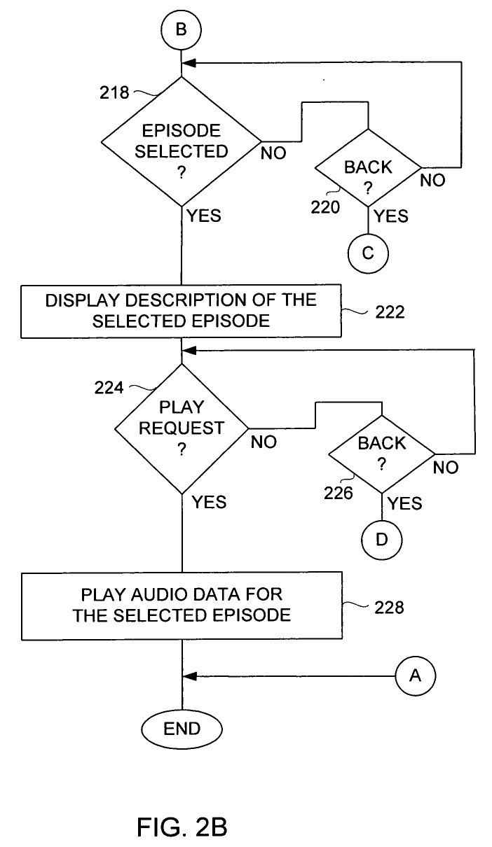

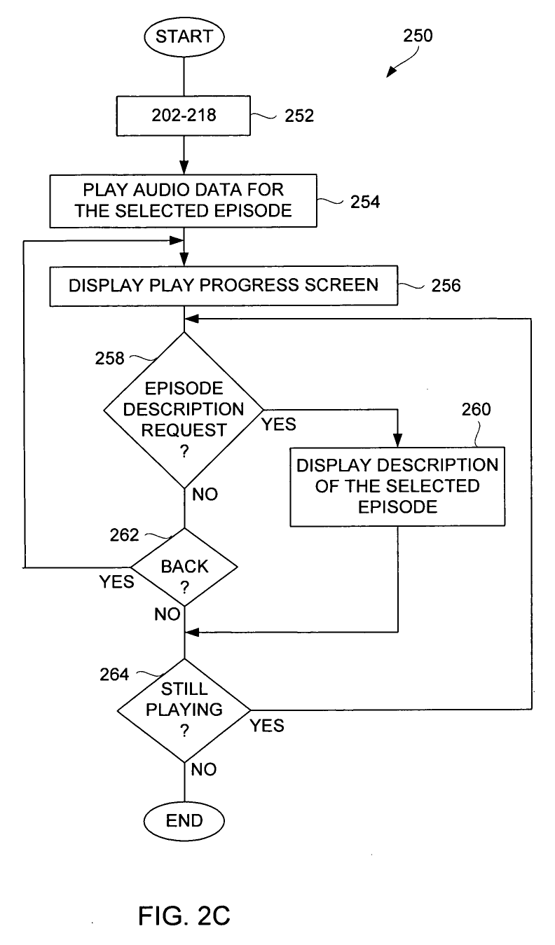

FIGS. 2A and 2B are flow diagrams of a podcast navigation process 200 according to one embodiment of the invention. The podcast navigation process 200 primarily concerns user navigation through a plurality of lists to identify and then play a particular podcast. The podcast navigation process 200 can represent a more detailed implementation of the podcast utilization process 100 illustrated in FIG. 1, namely, the navigation 102 operation.

The podcast navigation process 200 initially displays 202 an audio categories list. A decision 204 then determines whether a podcast category has been selected from the audio categories list. When the decision 204 determines that a podcast category has not been selected, a decision 206 determines whether another selection has been made. When the decision 206 determines that another selection has not been made, then the podcast navigation process 200 returns to repeat the decision 204. On the other hand, when the decision 206 determines that another selection has been made, other processing is performed 208 so as to carry out the other selection.

Alternatively, when the decision 204 determines that a podcast category has been selected, a list of titles of available podcasts is displayed 210. Typically, the available podcasts are the podcasts that are stored on the portable media device.

Next, a decision 212 determines whether a podcast has been selected. Here, the decision 212 determines whether a podcast has been selected from the list of titles of the available podcasts being displayed 210. In other words, selecting one of the titles from the list of titles operates to select a podcast. The podcast being selected can also be referred to as a show (or episode). When the decision 212 determines that a podcast has not yet been selected, a decision 214 determines whether a back request has been received. A back request is a navigation request to go back one previous level in the navigation hierarchy. When the decision 214 determines that a back request has been received, then the podcast navigation process 200 returns to repeat the block 202. On the other hand, when the decision 214 determines that a back request has not been received, the podcast navigation process 200 returns to repeat the decision 212 to await a podcast selection.

Once the decision 212 determines that a podcast has been selected, a list of names of episodes available for the selected podcast are displayed 216. A decision 218 then determines whether an episode has been selected. Here, the decision 218 determines whether one of the episodes identified in the list of names of episodes being displayed 216 has been selected. When the decision 218 determines that an episode has not been selected, a decision 220 determines whether a back request has been received. When the decision 220 determines that a back request has been received, the podcast navigation process 200 returns to repeat the block 210. On the other hand, when the decision 220 determines that a back request has not been received, the podcast navigation process 200 returns to repeat the decision 218.

Once the decision 218 determines that an episode has been selected, a description of the selected episode is displayed 222. Thereafter, a decision 224 determines whether a play request has been received. Here, the play request would be a request by a user of the portable media device to play the selected episode. When the decision 224 determines that a play request has not yet been received, a decision 226 determines whether a back request has been received. When the decision 226 determines that a back request has been received, the podcast navigation process 200 returns to repeat the block 216. On the other hand, when the decision 226 determines that a back request has not been received, the podcast navigation process 200 returns to repeat the decision 224.

When the decision 224 determines that a play request has been received, audio data for the selected episode is played 228 by the portable media device. Following the block 228, as well as following the block 208, the podcast navigation process 200 ends.

FIG. 2C is a flow diagram of a podcast navigation process 250 according to another embodiment of the invention. The podcast navigation process 250 is generally similar to the podcast navigation process 200 illustrated in FIGS. 2A and 2B, though the primary difference concerns when an episode description is displayed.

The podcast navigation process 250 begins with block 252 that represents, in summary fashion, the blocks 202 through 218 discussed above with respect to FIGS. 2A and 2B. Following the block 252, audio data for the selected episode is played 254. While the audio data for the selected episode is being played 254, a played progress screen is typically displayed 256. The play progress screen, in general, provides information concerning the podcast to the user of the portable media device. As an example, the play progress screen provides information on the extent to which the selected episode has been played or is yet to play.

Next, a decision 258 can determine whether an episode description request has been received. An episode description request can be initiated by a user of the portable media device. As an example, a user may interact with a button, switch or sensor on the portable media device to initiate an episode description request. When the decision 258 determines that an episode description request has been received, a description of the selected episode is displayed 216. Typically, the display screen for the portable media player is relatively small. Hence, when the description in the selected episode is displayed 260, the play progress screen is removed (i.e., not displayed).

Alternatively, when the decision 258 determines that an episode description request has not been received, a decision 262 determines whether a back request has been received. The back request is typically a user request to return back to the play progress screen. Here, assuming that the description of the selected episode was previously requested and thus being displayed, the back request would operate to cause the play progress screen to be displayed 256 and the description of the selected episode removed. On the other hand, when the decision 262 determines that a back request has not been received, as well as following the block 260, a decision 264 determines whether the selected episode is still being played. When the decision 264 determines that the selected episode is still being played, the podcast navigation process 250 returns to repeat the decision 258 and subsequent operations. Alternatively, when the decision 264 determines that the selected episode is no longer playing, the podcast navigation process 250 ends.

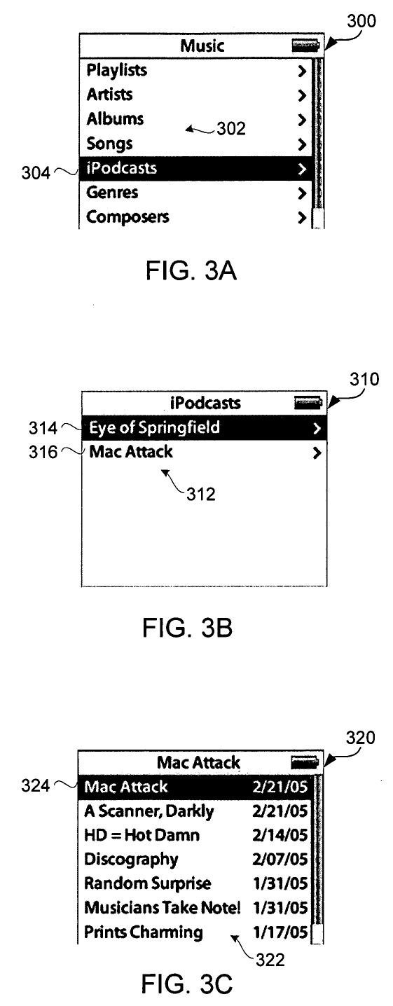

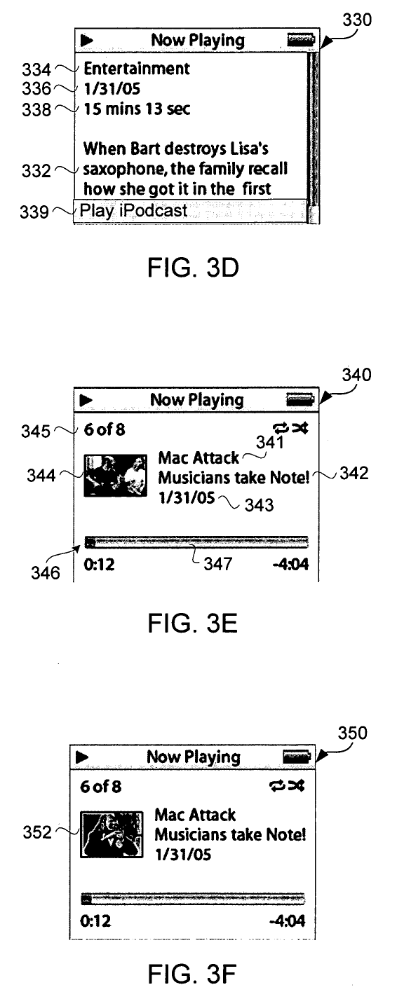

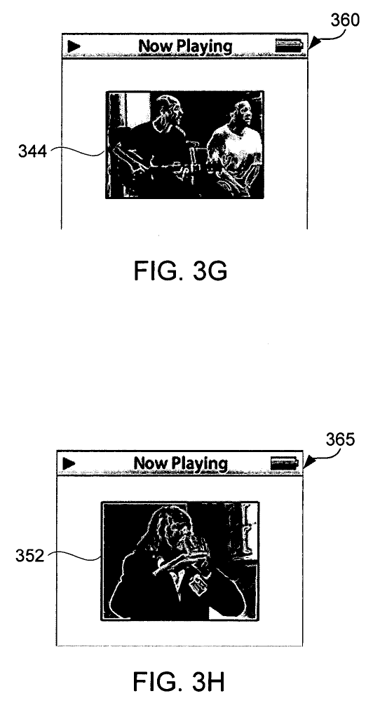

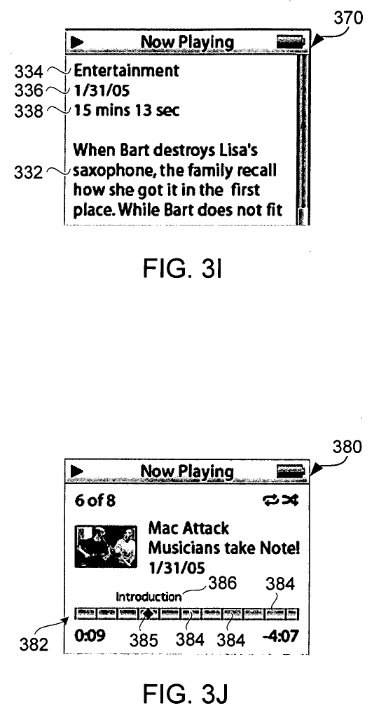

FIGS. 3A-3D represent a series of representative screen shots of navigation screens that can be displayed on a display screen of a portable media device to assist its user in navigating through a plurality of podcasts to select and then play a desired one of the podcasts. The navigation screens (e.g., navigation windows) can provide a hierarchy of lists that permit a user to conveniently navigate through the plurality of podcasts to select one of the podcasts to be played. In one embodiment, the lists being utilized can be implemented as menus.

FIG. 3A is a screen shot of a first navigation window 300 according to one embodiment of the invention. The navigation window 300 contains a list 302 of selectable items. As an example, the selectable items in the list 302 can pertain to categories of audio. A particular one of the selectable items in the list 302 is denoted “iPodcasts” which is a selectable item 304 that can be chosen to navigate to view available podcasts.

FIG. 3B is a screen shot of a second navigation window 310 according to one embodiment of the invention. As an example, the second navigation window 310 can be produced in response to the selection of the selectable item 304 from the list 302 of the first navigation window 300. The navigation window 310 contains a list 312 of selectable items. As an example, the selectable items in the list 312 can pertain to titles or names of podcasts. Specifically, the list 312 includes a first selectable item 314 denoted “Eye of Springfield” and a second selectable item 316 denoted “Mac Attack”. Selection of one of the selectable items (i.e., one of the identified podcasts) in the list 312 causes navigation to the selected podcast.

FIG. 3C is a screen shot of a third navigation window 320 according to one embodiment of the invention. As an example, the third navigation window 320 can be produced in response to the selection of the selectable item 316 (selected podcast) from the list 312 of the second navigation window 310. The navigation window 320 contains a list 322 of selectable items. As an example, the selectable items in the list 322 can pertain to titles or names of episodes of the previously selected podcast. Specifically, the list 322 includes a first selectable item 324 denoted “Mac Attack”. Selection of one of the selectable items (i.e., episodes) in the list 322 causes navigation to the selected episode.

FIG. 3D is a screen shot of an episode window 330 according to one embodiment of the invention. As an example, the episode window 330 can be produced in response to the selection of a selectable item from the list 322 of the third navigation window 320. However, in this example, the episode window 330 pertains to an episode of the podcast entitled “Eye of Springfield” corresponding to the first selectable item 314 in the list 312 illustrated in FIG. 3B. Regardless of the corresponding podcast, the format of the information presented in the episode window 330 is generally the same. In this regard, the episode window 330 contains an episode description 332 which briefly describes the episode. In addition, the episode window 330 can further contain a category 334, a publication date 336 and a length (or duration) 338 of the episode. In this example, the category 334 is “Entertainment”, the publication date is “Jan. 31, 2005”, and the length (or duration) is “15 mins 13 sec” (i.e., 15 minutes and 13 seconds). Still further, the episode window 330 includes a play request selectable item 339. Selection of the play request selectable item 339 causes the selected episode to begin being played.

Although not shown in FIGS. 3A-3C, podcasts can also be navigated using categories. In other words, a portable media device (as well as a host computer) can also organize podcasts into different categories to facilitate their selection by users. Examples of categories include: Arts & Entertainment, Biography and Memoir, Business, Classics, Comedy, Drama & Poetry, Fiction, History, Kids & Young Adults, Languages, Mystery, and News.

According to another aspect, while a podcast is being played at a portable media device, metadata associated with the podcast can be displayed or otherwise presented via the portable media device. In one embodiment, metadata can be presented on a display screen of the portable media device. More particularly, and in accordance with one embodiment, metadata for a podcast can be updated while the podcast is being played. In other words, the metadata for any particular podcast can vary over time such that the metadata changes while the podcast is being played. The updating of the metadata is preferably done in an automatic manner such that the metadata appears dynamic. In one implementation, the podcast itself can include control information which can be used by the portable media device to control when and how metadata for the podcast is updated.

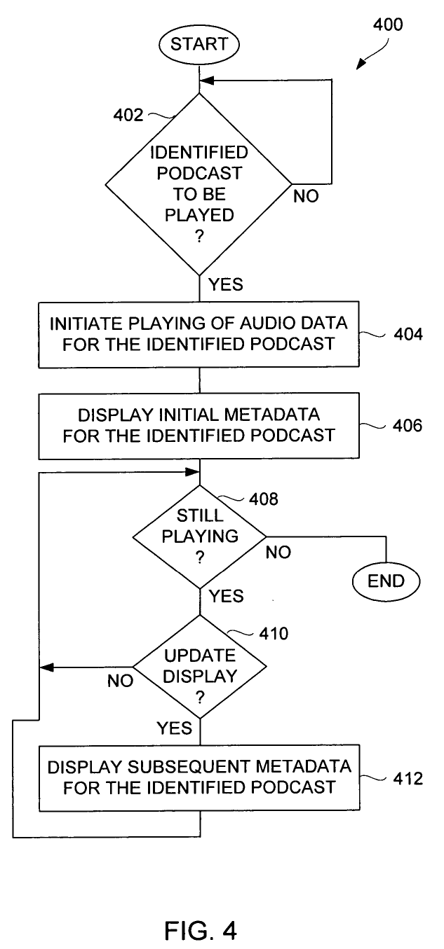

FIG. 4 is a flow diagram of a metadata update process 400 according to one embodiment of the invention. The metadata update process 400 is typically performed on a portable media device while playing a podcast.

The metadata update process 400 begins with a decision 402 that determines whether an identified podcast is to be played. A podcast can be identified to be played using techniques discussed above. When the decision 402 determines that a podcast has not been identified to be played, the metadata update process 400 awaits such a condition. In other words, the metadata update process 400 is performed when an identified podcast is to be played.

Once the decision 402 determines that an identified podcast is to be played, playing of the audio data for the identified podcast is initiated 404 at the portable media device. Additionally, initial metadata for the identified podcast is displayed 406. Typically, the initial metadata would be displayed 406 on a display screen associated with the portable media device that performs the metadata update process 400.

Next, a decision 408 determines whether the audio data for the identified podcast is still playing. When the decision 408 determines that the audio data for the identified podcast is still playing, a decision 410 determines whether the display of metadata should be updated. When the decision 410 determines that the display of metadata should be updated, subsequent metadata for the identified podcast is then displayed 412. The subsequent metadata to be displayed also pertains to the identified podcast. The subsequent metadata can be provided with the podcast. For example, the subsequent metadata to be displayed can be automatically chosen based on elapsed time of the podcast, segment (e.g., chapter) being played, or randomly. Alternatively, the subsequent metadata could be chosen or influenced by user input to the portable media device.

After the subsequent metadata is displayed 412, or directly following the decision 410 when the metadata is not to be updated, the metadata update process 400 returns to repeat the decision 408. Eventually, when the decision 408 determines that the audio data for the identified podcast is no longer playing (e.g., after the audio data has been completely played), the metadata update process 400 ends.

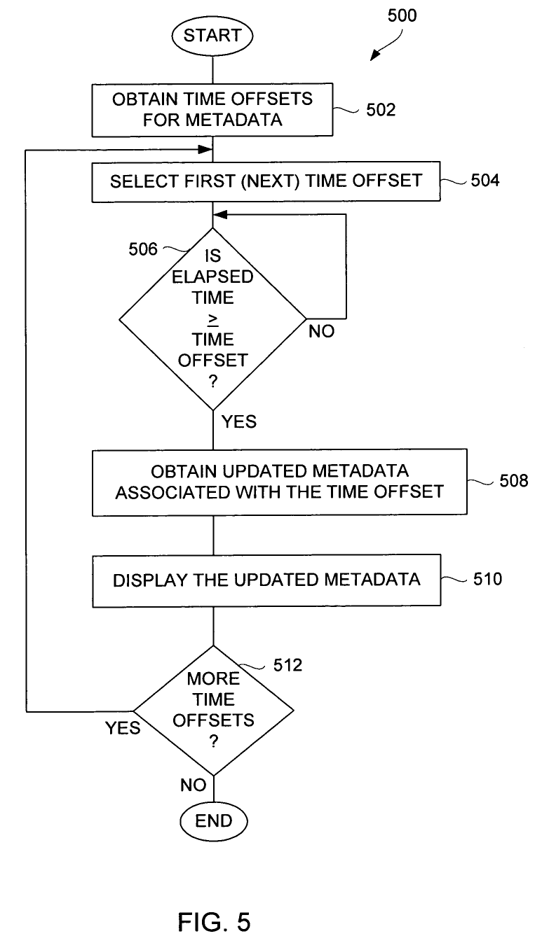

FIG. 5 is a flow diagram of a dynamic metadata process 500 according to one embodiment of the invention. The dynamic metadata process 500 is, for example, performed by a portable media device when playing a podcast. The podcast has metadata associated therewith to provide information concerning the podcast. The metadata can include text and/or images. The metadata can also include time offsets that signal when different portions of the metadata are to be displayed. The dynamic metadata process 500 can represent one implementation for the decision 410 and the displaying 412 of the metadata update process 400 described above with reference to FIG. 4.

The dynamic metadata process 500 initially obtains 502 time offsets for the metadata. The time offsets are used in determining which portion of the metadata is to be presented (e.g., displayed). After the time offsets for the metadata have been obtained 502, a first time offset is selected 504. A decision 506 then determines whether the elapsed time for the podcast is greater than or equal to the selected time offset. Here, in general, the elapsed time is the time that the podcast has been playing. When the decision 506 determines that the elapsed time is not greater than or equal to the selected time offset, the dynamic metadata process 500 waits until such condition has been satisfied. Once the decision 506 determines that the elapsed time for the playing of the podcast is greater than or equal to the selected time offset, updated metadata associated with the time offset is obtained 502. Typically, the updated metadata is provided with the podcast such that a read or look-up operation can be used to obtain 502 the time offset. After the updated metadata has been obtained 508, the updated metadata is displayed 510. Typically, the updated metadata would be displayed 510 on a display screen of the portable media device. Thereafter, a decision 512 determines whether there are more time offsets to be processed. When the decision 512 determines that there are more time offsets to be processed, the dynamic metadata process 500 returns to repeat the block 504 so that a next time offset can be selected and then similarly processed. Once the decision 512 determines that there are no more time offsets to be processed, the dynamic metadata process 500 ends.

FIGS. 3E-3I represent screen shots that depict different representative metadata pertaining to a podcast being played on a portable media device. The metadata serves to inform the user about the podcast being played.

FIG. 3E is a screen shot of a podcast playing window 340 according to one embodiment of the invention. As an example, the podcast playing window 340 can be produced in response to the selection of the play request selectable item 339. The podcast playing window 340 presents an example of initial metadata on a display screen on the portable media device. In this example, the metadata includes a podcast name 341 (“Mac Attack”), an episode name 342 (“Musicians Take Note”), a publication date 343 (“Jan. 31, 2005”), and a first image 344. The podcast playing window 340 also includes an episode index number 345. In this example, the episode index number 345 indicates “6 of 8” meaning that the sixth of eight available episodes of the podcast is being played. Still further, the podcast playing window 340 can include play time feedback 346 including a progress bar 347.

FIG. 3F is a screen shot of a podcast playing window 350 according to another embodiment of the invention. The podcast playing window 350 represents an updated version of the podcast playing window 340. In particular, the podcast playing window 350 is generally similar to the podcast playing window 340 except that the first image 344 is replaced by a second image 352. Hence, in this example, at least the second image 352 of the podcast playing window represents updated metadata or subsequent metadata.

The image portion of the metadata for a podcast can also be presented in an image mode on a display screen of portable media device. In the image mode, the metadata display is substantially or exclusively an image of the metadata. FIG. 3G is a screen shot of a podcast playing window 360 according to one embodiment of the invention. The podcast playing window 360 depicts the first image 344 from the podcast playing window 340 in a full screen mode. FIG. 3H is a screen shot of a podcast playing window 365 according to one embodiment of the invention. The podcast playing window 365 depicts the second image 352 from the podcast playing window 350 in a full screen mode.

FIG. 31 is a screen shot of a podcast playing window 370 according to still another embodiment of the invention. The podcast playing window 370 is generally similar to the episode window 330 shown in FIG. 3D, except that the play request selectable item 339 is not provided because the episode is already playing in this embodiment. As an example, the podcast playing window 370 can be produced while audio data for the episode is being played in response to an episode description request as illustrated in blocks 258 and 260 of FIG. 2C.

According to another aspect, chapter information can be presented at a portable media device. A podcast can be segmented into different chapters as transitions between topics or discussions. Each chapter can have different chapter information that is presented while the corresponding chapter is being presented. The chapter information is also considered metadata. The chapter information being presented can be either requested by a user or automatically requested by the portable media device.

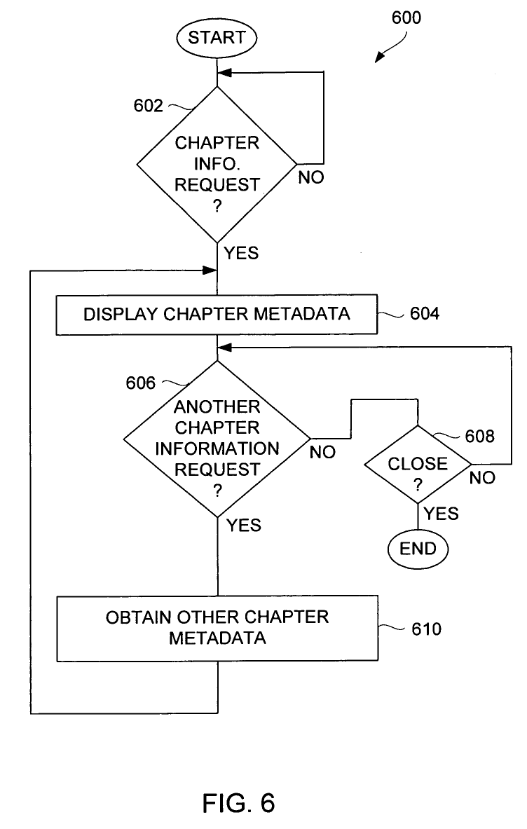

FIG. 6 is a flow diagram of a chapter metadata presentation process 600 according to one embodiment of the invention. The chapter metadata presentation process 600 is, for example, performed by a portable media device.

The chapter metadata presentation process 600 begins with a decision 602 that determines whether chapter information has been requested. Here, the chapter information can be requested by a user or can be requested by the portable media device. The chapter information is chapter metadata for a corresponding chapter of a podcast. When the decision 602 determines that chapter information has not been requested, then the chapter metadata presentation process 600 awaits such request. On the other hand, when the decision 602 determines that chapter information has been requested, the chapter metadata presentation process 600 continues. In other words, the chapter metadata presentation process 600 can be deemed invoked when a chapter information request has been received. The chapter information request can be either automatically produced or produced by a user. For example, the chapter information request can be automatically requested, such as during a dynamic metadata process 500 as shown in FIG. 5. Alternatively, as an example, the chapter information request can be manually requested by a user whenever desired by the user.

In any event, once the decision 602 determines that a chapter information request has been requested, chapter metadata is displayed 604. Here, the podcast is deemed to be divided into a plurality of sequential chapters. Each of the chapters can have specific metadata, namely, chapter metadata, associated therewith. Hence, the display 604 of the chapter metadata can operate to display the particular chapter metadata depending upon a chapter of interest. For example, an initial chapter of a podcast can be referred to as an introductory chapter. After the chapter metadata for the initial chapter has been displayed 604, a decision 606 determines whether another chapter request has been received. Here, another chapter request would correspond to a request for chapter information for another chapter of the podcast. When the decision 606 determines that another chapter information request has not been received, a decision 608 determines whether the chapter metadata presentation process 600 should be closed. When the decision 608 determines that the chapter metadata presentation process 600 should be closed, then the chapter metadata presentation process 600 ends. On the other hand, when the decision 608 determines that the chapter metadata presentation process 600 should not closed, then the chapter metadata presentation process 600 returns to repeat the decision 606.

Alternatively, when the decision 606 determines that another chapter information request has been received, then other chapter metadata is obtained 610. Following the block 610, the chapter metadata presentation process 600 returns to repeat the block 604 and subsequent operations so that the other chapter metadata can be displayed 604.

FIG. 3J is a screen shot of a podcast playing window 380 according to one embodiment of the invention. The podcast playing window 380 represents a version of the podcast playing window 340 after which a user has requested to view chapter information. In particular, the podcast playing window 380 is generally similar to the podcast playing window 340 in that podcast metadata is displayed, such as a podcast name (“Mac Attack”), an episode name (“Musicians Take Note”), a publication date (“Jan. 31, 2005”), and an image. Moreover, to present the chapter information, the podcast playing window 380 further presents a chapter navigation tool 382. In this example, the chapter navigation tool 382 is represented as a horizontal bar with segmentations 384. Each of the segmentations 384 represents a different chapter. A chapter selector 385 operates to select a particular chapter for which chapter information 386 is to be presented. Hence, the user can navigate through the segments 384 to locate the chapter selector 385 over a chapter of interest, and thereby cause the corresponding chapter information to be displayed. As shown in FIG. 3J, the chapter selector 385 has been navigated to a particular segment 384 of the horizontal bar and the corresponding chapter information 386, namely, its title (e.g., “Introduction”), is displayed on the display screen of the portable media device. Although the chapter navigation tool 382 is depicted as a horizontal bar in FIG. 3J, it should be understood that chapter navigation and presentation of chapter information can be implemented in various other ways.

In another embodiment, if chapter information is available, a user can interact with a portable media player to navigate through numerous podcasts to select a specific chapter of a podcast (e.g., episode). One example of such an embodiment would be similar to the podcast navigation process 200 illustrated in FIGS. 2A and 2B, except that between blocks 218 and block 222, an additional block would operate to display a list of chapters of the selected episode. Another example of such an embodiment would be similar to the podcast navigation process 250 illustrated in FIG. 2C, except that between blocks 252 and block 254, an additional block would operate to display a list of chapters of the selected episode. In either case, the user would select a desired one of the chapters to be played.

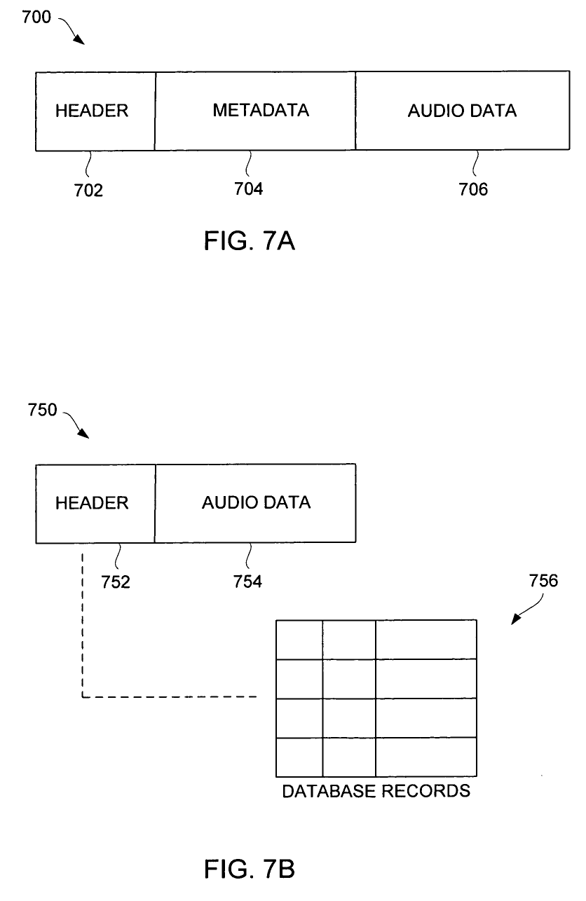

FIG. 7A is a diagram of a representative electronic file 700 pertaining to a podcast according to one embodiment of the invention. In particular, the electronic file 700 includes a header 702, metadata 704 and audio data 706. More generally, the electronic file includes audio data for the podcast and metadata pertaining to the podcast. The metadata specific to particular chapters can also be distinguished so as to facilitate its display with respect to corresponding chapters.

FIG. 7B is a diagram of a representative electronic file 750 pertaining to a podcast according to another embodiment of the invention. In this embodiment, the electronic file 750 includes a header 752 and audio data 754. The metadata for the podcast is separate from the electronic file 750 that carries the audio data. In particular, in this embodiment, the metadata can be stored in database records 756 of a database that resides on the portable media device. The metadata can thereafter be retrieved from the database and presented (e.g., displayed) at appropriate times. The metadata can also include control information that specifies when and perhaps how certain metadata is to be presented.

The portable media devices and their operations discussed above can be used within a media system that supports purchase, management and usage of media assets.

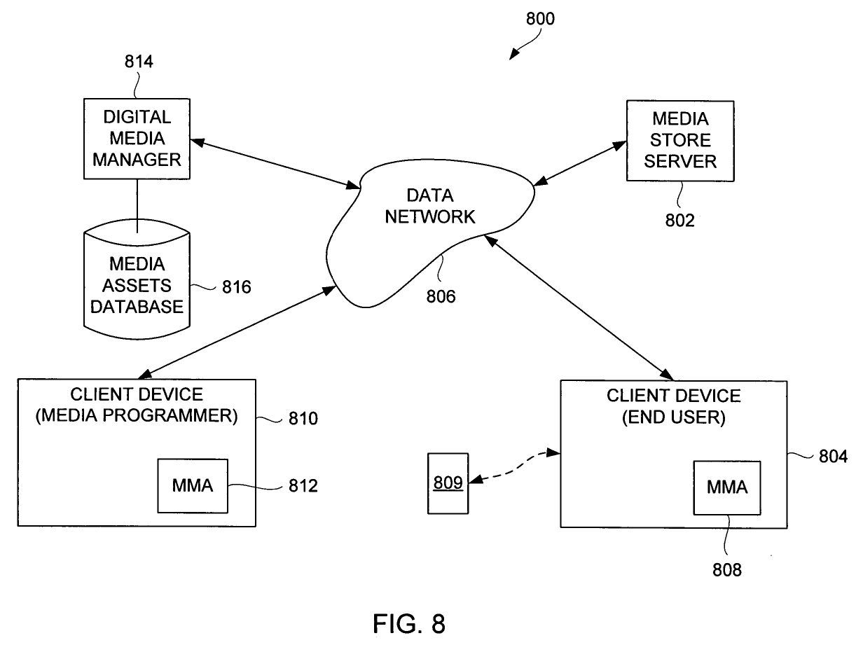

FIG. 8 is a block diagram of a media system 800 according to one embodiment of the invention. The media system 800 includes a media store server 802 that hosts an on-line media store. The media store server 802 can off-load commerce transactions and/or delivery of purchased digital media assets to other servers, if desired. As shown in FIG. 8, the media system 800 includes one or more client devices 804 for use by end users. The client devices 804 couple to a data network 806. Additionally, the media store server 802 also couples to the data network 806. In one implementation, the data network 806 can refer to one or more data networks, typically high data-bandwidth networks; namely, wired networks, such as the Internet, Ethernet, gigabit Ethernet, and fiber optic, as well as wireless networks such as IEEE 802.11(a),(b) or (g) (WiFi), IEEE 802.16 (WiMax), and Ultra-Wide Band (UWB).

A computer program 808 (client or client application), typically a media management application (MMA) or other media player application, runs on the client device 804. One example of a media management application is the iTunes® application, produced by Apple Computer, Inc. of Cupertino, Calif. The client devices 804 are, in general, computing devices. As an example, the client devices 804 can be specific or general-purpose personal computers or portable media players. The client device can couple to a portable media device 809 (portable media player). One example of a portable media player suitable for use with the invention is the iPod®, also produced by Apple Computer, Inc. The computer program 808 can be used by a consumer for a variety of purposes, including, but not limited to, browsing, searching, acquiring and/or purchasing media assets (including podcasts) from the on-line media store provided by the media store server 802, creating and sharing media asset groups (e.g., playlists), organizing media assets, presenting/playing media assets, transferring media assets between client devices 804, and synchronizing with portable media devices.

The media system 800 can also include one or more client devices 810 for use by media programmers. The client devices 810 also run a computer program 812, typically a media management application (MMA) or other media player application. The computer program 812 can enable a media programmer to create and publish podcasts.

The media system 800 also includes a digital asset manager 814. The digital asset manager 814 is coupled to a media assets database 816. The media assets database 816 stores media asset information including metadata relating to digital media assets available for purchase at the on-line media store. The metadata can pertain to individual media assets (digital media assets) or media asset groups (digital media asset groups). Media assets can include, but are not limited to, music, video, text, and/or graphics files. One particular type of media asset is a podcast, which often includes audio, graphics and text (but could also include video). In the case of music, a media asset group can be a playlist for the music. One specific example of a type of digital media asset group is referred to as an iMix™, which is a published playlist currently available for browsing and/or purchase on Apple Computer's iTunes® Music Store. Another specific example of a type of digital media asset group is referred to as an iEssential™, which is a published playlist created by a media programmer and currently available for browsing and/or purchase on Apple Computer's iTunes® Music Store. Still another specific example of a type of digital media asset group is referred to as a Celebrity Playlist, which is a published playlist created by a celebrity and which could be made available for browsing and/or purchase on Apple Computer's iTunes® Music Store.

The media store server 802 enables the user of a particular client device 804 to acquire media assets (e.g., podcasts). Subsequently, the client device 804 can download the media assets from the media store server 802 or some other server via the data network 806. As will be understood by those familiar with data networks, other network configurations are possible. Furthermore, while the media store server 802 and the digital asset manager 814 are shown as individual and separate devices, it will be understood by those familiar with the art that other configurations are possible. As one example, each device can be implemented such that it is distributed over multiple server computers. As another example, these various servers and/or managers can be implemented by a single physical server computer.

The portable media device as described herein can be a media player capable of playing (including displaying) media items. The media items can pertain to audio items (e.g., audio files or songs), videos (e.g., movies) or images (e.g., photos). One particular type of media item is a podcast.

According to another aspect, a portable media device can also connect to a host computer, such as a personal computer. The personal computer can store, utilize and manage media items (e.g., podcasts). The management of the media items can be not only for the host computer but also for the portable media device.

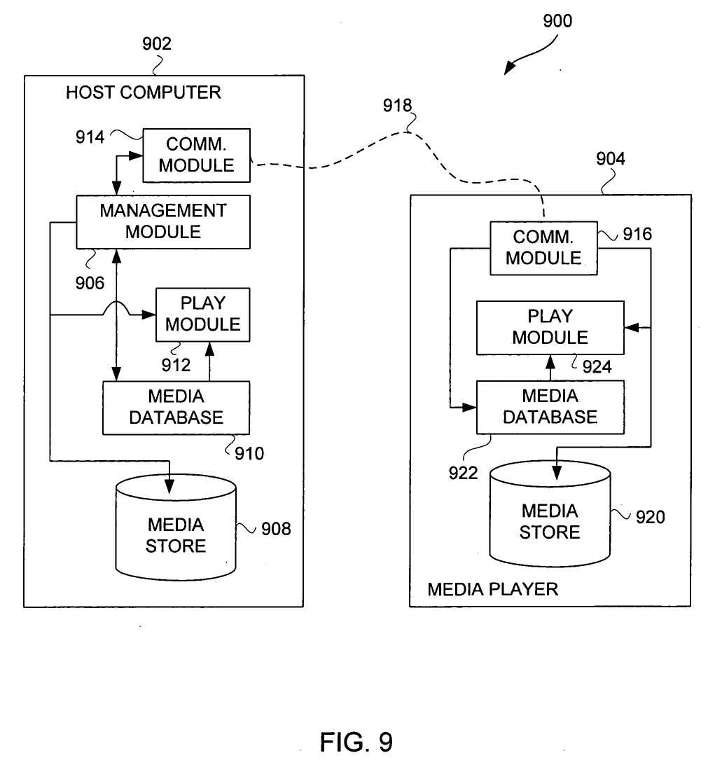

FIG. 9 is a block diagram of a media management system 900 according to one embodiment of the invention. The media management system 900 includes a host computer 902 and a media player 904. The host computer 902 is typically a personal computer. The host computer, among other conventional components, includes a management module 906 which is a software module. The management module 906 provides for centralized management of media items (and/or playlists) not only on the host computer 902 but also on the media player 904. More particularly, the management module 906 manages those media items stored in a media store 908 associated with the host computer 902. The management module 906 also interacts with a media database 910 to store media information associated with the media items stored in the media store 908.

The media information pertains to characteristics or attributes of the media items. For example, in the case of audio or audiovisual media, the media information can include one or more of: title, album, track, artist, composer and genre. These types of media information are specific to particular media items. In addition, the media information can pertain to quality characteristics of the media items. Examples of quality characteristics of media items can include one or more of: bit rate, sample rate, equalizer setting, volume adjustment, start/stop and total time. As another example, the media information (e.g., podcast metadata) for media items that are podcasts can include one or more of title, description, chapter names, and images (graphics).

Still further, the host computer 902 includes a play module 912. The play module 912 is a software module that can be utilized to play certain media items stored in the media store 908. The play module 912 can also display (on a display screen) or otherwise utilize media information from the media database 910. Typically, the media information of interest corresponds to the media items to be played by the play module 912. For example, in the case of podcasts being played, media information (e.g., metadata) corresponding to the podcasts can be displayed.

The host computer 902 also includes a communication module 914 that couples to a corresponding communication module 916 within the media player 904. A connection or link 918 removably couples the communication modules 914 and 916. In one embodiment, the connection or link 918 is a cable that provides a data bus, such as a FIREWIRE™ bus or USB bus, which is well known in the art. In another embodiment, the connection or link 918 is a wireless channel or connection through a wireless network. Hence, depending on implementation, the communication modules 914 and 916 may communicate in a wired or wireless manner.

The media player 904 also includes a media store 920 that stores media items within the media player 904. Optionally, the media store 920 can also store data, i.e., non-media item storage. The media items being stored to the media store 920 are typically received over the connection or link 918 from the host computer 902. More particularly, the management module 906 sends all or certain of those media items residing on the media store 908 over the connection or link 918 to the media store 920 within the media player 904. Additionally, the corresponding media information for the media items that is also delivered to the media player 904 from the host computer 902 can be stored in a media database 922. In this regard, certain media information from the media database 910 within the host computer 902 can be sent to the media database 922 within the media player 904 over the connection or link 918. Podcasts are one type of media item that can be managed in this manner.

Furthermore, the media player 904 includes a play module 924 that couples to the media store 920 and the media database 922. The play module 924 is a software module that can be utilized to play certain media items stored in the media store 920. The play module 924 can also display (on a display screen) or otherwise utilize media information from the media database 922. Typically, the media information of interest corresponds to the media items to be played by the play module 924. For example, in the case where a podcast is to be played, media information (e.g., metadata) corresponding to the podcast can be displayed.

In one embodiment, the media player 904 has limited or no capability to manage media items on the media player 904. However, the management module 906 within the host computer 902 can indirectly manage the media items residing on the media player 904. For example, to “add” a media item to the media player 904, the management module 906 serves to identify the media item to be added to the media player 904 from the media store 908 and then causes the identified media item to be delivered to the media player 904. As another example, to “delete” a media item from the media player 904, the management module 906 serves to identify the media item to be deleted from the media store 908 and then causes the identified media item to be deleted from the media player 904. As still another example, if changes (i.e., alterations) to characteristics of a media item were made at the host computer 902 using the management module 906, then such characteristics can also be carried over to the corresponding media item on the media player 904. In one implementation, the additions, deletions and/or changes occur in a batch-like process during synchronization of the media items on the media player 904 with the media items on the host computer 902.

In another embodiment, the media player 904 has limited or no capability to manage podcasts on the media player 904. However, the management module 906 within the host computer 902 through management of the podcasts residing on the host computer can indirectly manage the podcasts residing on the media player 904. In this regard, additions, deletions or changes to podcasts can be performed on the host computer 902 and then be carried over to the media player 904 when delivered thereto. Also, the media player 1104 can mark a podcast as having been played so that the management module 906 can determine to remove it from the media player 904. In one embodiment, the removal of podcasts from the media player 904 can be based on a preference setting at the host computer 902 and/or the media player 904. For example, a preference setting at the host computer 902 could indicate a user preference to remove podcasts from the media player 904 after they have been played.

As previously noted, synchronization is a form of media management. The ability to automatically initiate synchronization was also previously discussed above and in the related application noted above. Still further, however, the synchronization between devices can be restricted sodas to prevent automatic synchronization when the host computer and media player do not recognize one another.

According to one embodiment, when a media player is first connected to a host computer (or even more generally when matching identifiers are not present), the user of the media player is queried as to whether the user desires to affiliate, assign or lock the media player to the host computer. When the user of the media player elects to affiliate, assign or lock the media player with the host computer, then a pseudo-random identifier is obtained and stored in either the media database or a file within both the host computer and the media player. In one implementation, the identifier is an identifier associated with (e.g., known or generated by) the host computer or its management module and such identifier is sent to and stored in the media player. In another implementation, the identifier is associated with (e.g., known or generated by) the media player and is sent to and stored in a file or media database of the host computer.

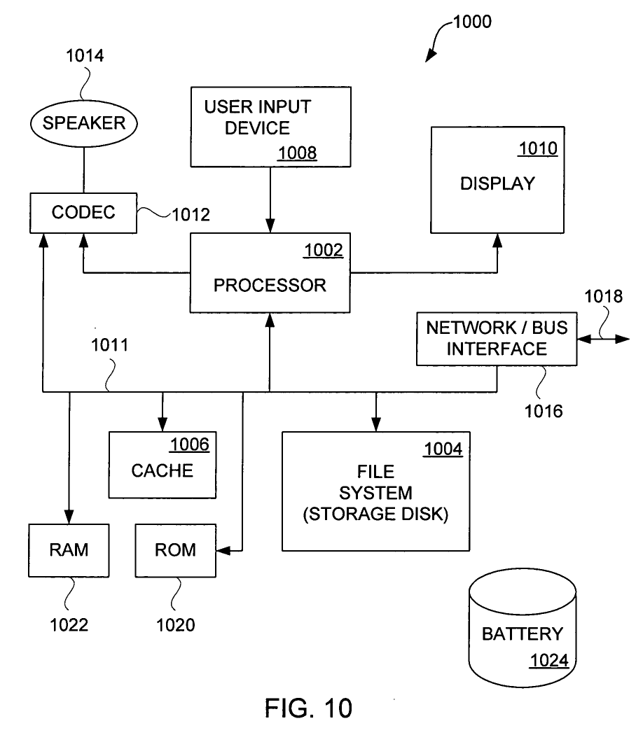

FIG. 10 is a block diagram of a media player 1000 suitable for use with the invention. The media player 1000 illustrates circuitry of a representative portable media device.

The media player 1000 includes a processor 1002 that pertains to a microprocessor or controller for controlling the overall operation of the media player 1000. The media player 1000 stores media data pertaining to media items in a file system 1004 and a cache 1006. The file system 1004 is, typically, a storage disk or a plurality of disks. The file system 1004 typically provides high capacity storage capability for the media player 1000. However, since the access time to the file system 1004 is relatively slow, the media player 1000 can also include a cache 1006. The cache 1006 is, for example, Random-Access Memory (RAM) provided by semiconductor memory. The relative access time to the cache 1006 is substantially shorter than for the file system 1004. However, the cache 1006 does not have the large storage capacity of the file system 1004. Further, the file system 1004, when active, consumes more power than does the cache 1006. The power consumption is often a concern when the media player 1000 is a portable media player that is powered by a battery (not shown). The media player 1000 also includes a RAM 1020 and a Read-Only Memory (ROM) 1022. The ROM 1022 can store programs, utilities or processes to be executed in a non-volatile manner. The RAM 1020 provides volatile data storage, such as for the cache 1006.

The media player 1000 also includes a user input device 1008 that allows a user of the media player 1000 to interact with the media player 1000. For example, the user input device 1008 can take a variety of forms, such as a button, keypad, dial, etc. Still further, the media player 1000 includes a display 1010 (screen display) that can be controlled by the processor 1002 to display information to the user. A data bus 1011 can facilitate data transfer between at least the file system 1004, the cache 1006, the processor 1002, and the CODEC 1012.

In one embodiment, the media player 1000 serves to store a plurality of media items (e.g., songs, podcasts, etc.) in the file system 1004. When a user desires to have the media player play a particular media item, a list of available media items is displayed on the display 1010. Then, using the user input device 1008, a user can select one of the available media items. The processor 1002, upon receiving a selection of a particular media item, supplies the media data (e.g., audio file) for the particular media item to a coder/decoder (CODEC) 1012. The CODEC 1012 then produces analog output signals for a speaker 1014. The speaker 1014 can be a speaker internal to the media player 1000 or external to the media player 1000. For example, headphones or earphones that connect to the media player 1000 would be considered an external speaker.

The media player 1000 also includes a bus interface 1016 that couples to a data link 1018. The data link 1018 allows the media player 1000 to couple to a host device (e.g., host computer or power source). The data link 1018 can also provide power to the media player 1000.

The media player 1000 also includes a network/bus interface 1016 that couples to a data link 1018. The data link 1018 allows the media player 1000 to couple to a host computer or to accessory devices. The data link 1018 can be provided over a wired connection or a wireless connection. In the case of a wireless connection, the network/bus interface 1016 can include a wireless transceiver. The media items (media assets) can pertain to one or more different types of media content. In one embodiment, the media items are audio tracks (e.g., songs, audiobooks, podcasts). In another embodiment, the media items are images (e.g., photos). However, in other embodiments, the media items can be any combination of audio, graphical or video content.

The various aspects, embodiments, implementations or features of the invention can be used separately or in any combination.

The invention is preferably implemented by software, hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different aspects, embodiments or implementations may yield one or more of the following advantages. One advantage of the invention is that podcasts can be located on a portable media device with greater ease and with more uniformity. Another advantage of the invention is that metadata pertaining to podcasts can be presented while podcasts are being played by a portable media device. Still further, the metadata being presented can be dynamically updated or altered as the podcasts are being played so as to provide an improved presentation for users.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for utilizing podcasts on a portable media device, said method comprising:
(a) navigating, in response to user navigation inputs, through a series of hierarchically ordered lists pertaining to podcasts that are stored on the portable media device, each of the podcasts being stored on the portable media device having audio data and metadata;
(b) selecting, in response to a user selection input, a podcast to be played following said navigation;
(c) initiating playing of audio data for the selected podcast by the portable media device;
(d) displaying, during the playing of at least an initial portion of the audio data, initial metadata for the selected podcast on a display associated with the portable media device; and
(e) displaying, during at least a subsequent portion of the playing of the audio data, subsequent metadata for the selected podcast on the display associated with the portable media device.

2. A method as recited in claim 1, wherein after said initiating (c), said displaying (d) and said displaying (e) are performed for a user of the portable media device.

3. A method as recited in claim 1, wherein the audio data is provided in an audio file stored on the portable media device, and wherein at least a portion of the initial metadata and the subsequent metadata are stored in a database on the portable media device.

4. A method as recited in claim 1, wherein the subsequent metadata is only partially different than the initial metadata.

5. A method as recited in claim 1,
wherein the initial metadata includes at least one text component and at least one graphical component,
wherein the subsequent metadata includes at least one text component and at least one graphical component, and
wherein at least the graphical component of the subsequent metadata is different than the graphical component of the initial metadata.

6. A method as recited in claim 1, wherein the initial metadata comprises a number of initial user interface components, and wherein the subsequent metadata comprises a number of subsequent user interface components, wherein at least one of the subsequent user interface components is different than any of the initial user interface components.

7. A method as recited in claim 1, wherein the initial portion pertains to a first chapter of the podcast, and wherein the subsequent portion pertains to a second chapter of the podcast.

8. A method as recited in claim 1, wherein the hierarchically ordered lists are menus.

9. A method as recited in claim 1, wherein the portable media player is a portable music player, a mobile telephone or a personal digital assistant.

10. A method for utilizing podcasts on a portable media device, said method comprising:
(a) navigating through a series of lists pertaining to podcasts that are stored on the portable media device, each of the podcasts being stored on the portable media device having audio data and metadata;
(b) subsequently selecting a podcast to be played following said navigation;
(c) initiating playing of audio data for the selected podcast by the portable media device; and
(d) displaying metadata for the selected podcast on a display associated with the portable media device, wherein at least a portion of the metadata being displayed is dependent on an elapsed play time for the selected podcast.

11. A method as recited in claim 10, wherein the lists are hierarchically ordered.

12. A method as recited in claim 10, wherein said displaying (d) automatically alters the metadata being displayed depending on the elapsed time without any user input.

13. A method as recited in claim 10, wherein the metadata for the selected podcast includes at least a plurality of images, and wherein the one of the images being displayed by said displaying (d) is dependent on an elapsed play time for the selected podcast.

14. A method as recited in claim 10,
wherein the selected podcast has a plurality of segments, and
wherein, for each of the segments, at least a portion of the metadata for the selected podcast being displayed is different.

15. A method as recited in claim 14, wherein the segments are chapters.

16. A method for utilizing podcasts on a portable media device, said method comprising:
(a) identifying a podcast stored on the portable media device;
(b) initiating playing of audio data for the identified podcast by the portable media device; and
(c) displaying metadata for the selected podcast on a display associated with the portable media device, said displaying (c) being concurrent with the playing of the audio data for the identified podcast.

17. A method as recited in claim 16, wherein at least a portion of the metadata being displayed is dependent on an elapsed play time for the identified podcast.

18. A method as recited in claim 17, wherein the metadata for the identified podcast includes at least a plurality of images, and wherein a particular one of the images being displayed by said displaying (c) is dependent on the elapsed play time for the identified podcast.

19. A method as recited in claim 16, wherein the identified podcast has a plurality of chapters, and
wherein at least a portion of the metadata being displayed is dependent on the chapter of the identified podcast being played.

20. A method as recited in claim 16, wherein the identified podcast has a plurality of chapters, and
wherein the metadata being displayed includes chapter metadata of the identified podcast being played.

21. A method as recited in claim 20, wherein the chapter metadata pertains to one of the chapters other than the chapter of the identified podcast being played.

22. A method as recited in claim 21, wherein the chapter metadata being displayed is dependent on a user input.

23. A method as recited in claim 16, wherein said displaying (c) comprises:
(c1) displaying initial metadata for the identified podcast; and
(c2) determining whether the metadata being displayed should be updated; and
(c3) displaying subsequent metadata for the identified podcast when said determining (c2) determines that the metadata being displayed should be updated.

24. A method for navigating media items available on a media device having a display screen, said method comprises:
(a) displaying a first list including at least audio categories, the audio categories including at least a podcast category;
(b) determining whether the podcast category has been selected from the first list;
(c) displaying a second list when said determining (b) determines that the podcast category has been selected, the second list including at least textual descriptors for available podcasts on the portable media device;
(d) determining whether one of the available podcasts has been selected from the second list;
(e) displaying a third list when said determining (d) determines that one of the available podcasts has been selected from the second list, the third list including at least textual descriptors for available episodes for the selected podcast; and
(f) determining whether one of the available episodes has been selected from the third list.

25. A method as recited in claim 24, wherein said method further comprises:
(g) displaying episode information when said determining (f) determines that one of the available podcasts has been selected from the third list, the episode information pertaining to the selected episode.

26. A method as recited in claim 25, wherein the episode information is a description for the selected episode.

27. A method as recited in claim 25, wherein said method further comprises:
(h) determining whether a play request has been received for the selected episode; and
(i) playing audio data for the selected episode.

28. A method as recited in claim 27, wherein said method further comprises:
(j) displaying metadata for the selected episode concurrent with said playing (i).

29. A method as recited in claim 28, wherein at least a portion of the metadata being displayed is dependent on an elapsed play time for the selected episode.

30. A method as recited in claim 24, wherein said method further comprises:
(g) determining whether a play request has been received for the selected episode; and
(h) playing audio data for the selected episode.

31. A method as recited in claim 30, wherein said method further comprises:
(i) displaying metadata for the selected episode concurrent with said playing (h).

32. A method as recited in claim 31, wherein at least a portion of the metadata being displayed is dependent on an elapsed play time for the selected episode.

33. A method as recited in claim 24, wherein said method further comprises:
(g) playing audio data for the selected episode; and
(h) displaying metadata for the selected episode concurrent with said playing (g).

34. A method as recited in claim 33, wherein said displaying (h) is performed in response to a user request.

35. A method as recited in claim 24, wherein said method further comprises:
(g) displaying a fourth list when said determining (f) determines that one of the available episodes has been selected from the third list, the fourth list including at least textual descriptors for available chapters for the selected episode.

36. A method as recited in claim 35, wherein said method further comprises:
(h) determining whether one of the available chapters for the selected episode has been selected from the fourth list; and
(i) playing audio data for the selected chapter.

37. A method as recited in claim 24, wherein the portable media device is a handheld media player.

38. A computer readable medium including at least computer program code for utilizing podcasts on a portable media device, said computer readable medium comprising:
computer program code for identifying a podcast stored on the portable media device;
computer program code for initiating playing of audio data for the identified podcast by the portable media device; and
computer program code for displaying metadata for the selected podcast on a display associated with the portable media device, said computer program code for displaying being concurrent with the playing of the audio data for the identified podcast.

39. In a portable, pocket-sized multimedia asset player, a method of selecting and playing a multimedia asset from a group of multimedia assets stored therein, comprising:
displaying at a home interface,
a playlist list item corresponding to a number of playlists stored in the multimedia asset player, wherein each playlist is a group of multimedia assets,
an artists item corresponding to all of a number of artists each of which is associated with at least one of the stored multimedia assets,
a songs list item associated with each of the stored multimedia assets; and
a podcasts list item corresponding to a number of playlists stored in the multimedia asset player;
highlighting a desired one of the playlist list item, the artists item, the songs list item or the podcasts list item;
receiving a selection of the highlighted item; and
automatically transitioning to a second interface based upon the selected item.

40. A method as recited in claim 39, wherein when the selected item is the podcasts list item, then the second interface is a podcast interface that includes at least one selectable podcast item associated with at least one podcast, wherein the podcast is associated with an audio file and metadata therefor.

41. A method as recited in claim 40, further comprising:
receiving a selection of the podcast item; and
automatically transitioning to a third interface that includes a selectable list of episodes corresponding to the selected podcast item.
